(19) United States
(12) Patent Application Publication
(10) Pub. No.: US 2010/0092930 A1
(43) Pub. Date: Apr. 15, 2010

(54) SYSTEM AND METHOD FOR AN INTERACTIVE STORYTELLING GAME

(76) Inventors: Martin Fletcher, Whitmore Lake, MI (US); Alan Aldworth, Ann Arbor, MI (US); William Kuchera, Ann Arbor, MI (US)

Correspondence Address: SCHOX PLC, 500 3rd Street, Suite 515, San Francisco, CA, 94107, US

(21) Appl. No.: 12/252,290

(22) Filed: Oct. 15, 2008

(51) Int. Cl. G09B 17/00

(52) U.S. Cl. 434/178

(57) ABSTRACT

The interactive storytelling game of the present invention includes a contextual story that includes at least one key story concept, a blank story scene, and a scene palette that includes at least one story object that is associated with the key story concept. The story object is adapted to be applied to the blank story scene to form a user-generated scene. A validation engine compares the user-generated scene with the contextual description.

### TECHNICAL FIELD

This invention relates generally to the children educational game field, and more specifically to a new and useful system and method for an interactive storytelling game to facilitate children reading comprehension.

### BACKGROUND

Many attempts have been made to combine the addictive and entertaining properties of video games with reading education. However, the resultant games often are reduced into simple question and answer game play, tedious repetitive tasks, or other games that not only fail to maintain the attention of a child but fail to take advantage of educational techniques known by cognitive scientists and educators. Thus, there is a need in the children education game field to create a new and useful reading comprehension game. This invention provides such a new and useful reading comprehension game.

### BRIEF DESCRIPTION OF THE FIGURES

FIG. 1 is a schematic diagram of the preferred embodiment of the invention.

FIG. 2 is a detailed view of the contextual story of FIG. 1.

FIG. 3 is a detailed view of the blank story scene and scene palette of FIG. 1.

FIG. 4 is a detailed view of a user-generated scene using the blank story scene and scene palette of the preferred embodiment.

FIG. 5 is a flowchart diagram of the preferred embodiment of the invention.

### DESCRIPTION OF THE PREFERRED EMBODIMENTS

The following description of preferred embodiments of the invention is not intended to limit the invention to these preferred embodiments, but rather to enable any person skilled in the art to make and use this invention.

### 1. Interactive Storytelling Game System

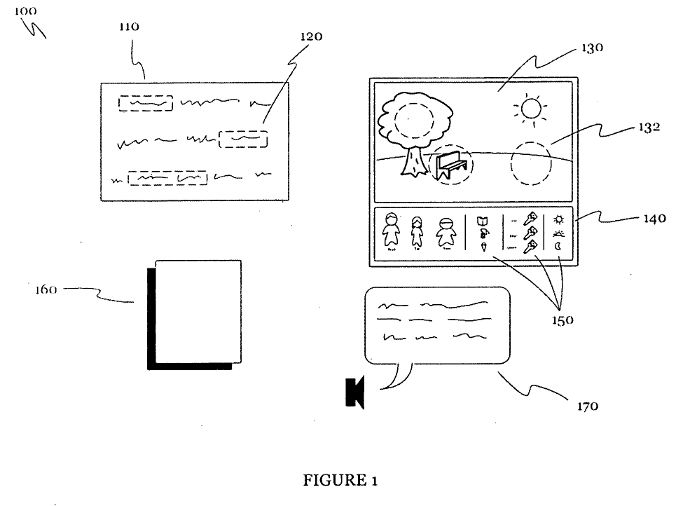

As shown in FIG. 1, the interactive storytelling game system 100 of the preferred embodiment includes a contextual story 110 that includes at least one key story concept 120, a blank story scene 130, a scene palette 140 including a plurality of story objects 150 and at least one story object 150 representing the at least one key concept 120, and validation software 160 to compare a contextual story 110 and a user-generated scene. The interactive storytelling game system 100 functions to force the user to hold information in working memory as they recode the information for game interactions. The interactive storytelling game 100 further functions to be a game that children are motivated to play while developing thinking and reading skills. The interactive storytelling game 100 is preferably implemented as a software program such as in a web application, but the interactive storytelling game 100 may alternatively be implemented in an electronic board game (using RFID tags and readers, optical sensors, or any suitable electrical identification sensors).

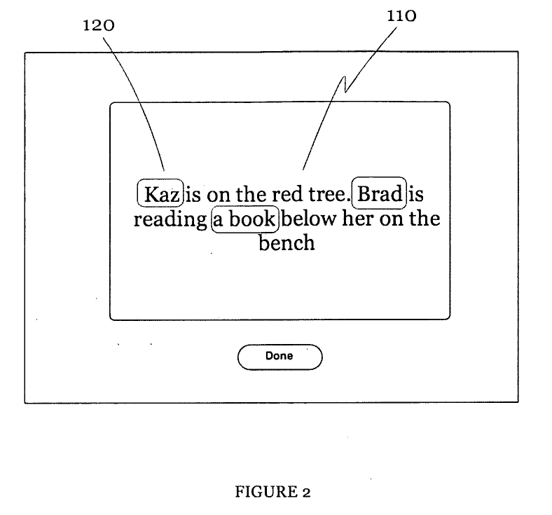

As shown in FIG. 2, the contextual story 110 of the preferred embodiment functions to provide a model story or description that a user will attempt to recreate in a user-generated scene. The contextual story 110 is preferably a two to three sentence textual description of a scene presented on a computer screen, but the text of the contextual story 110 may alternatively be of any suitable length. The contextual story 110 is preferably adjusted to match any suitable difficulty level. The contextual story 110 may be a sentence containing a few words at a low age or beginner level. At an older or advanced level, the contextual story 110 may be a long paragraph with use of complex syntax, multiple inferences, extraneous information, and/or any suitable elements to increase complexity. The contextual story may alternatively be set to any suitable difficulty level. Additionally, the difficulty level of the contextual story 110 may be adjusted automatically based on user performance. For example, successful completion of a game preferably causes a following game to have increased difficulty, and failure to complete a game preferably causes a following game to have decreased difficulty. In a variation of the preferred embodiment, the contextual story 110 is presented to the user in the form of audible speech, images, video, or any multimedia depiction of the contextual story 110. The contextual story 110 preferably includes at least one key story concept 120. The contextual story 110 is preferably stored in a software database of predefine contextual stories 110, but may alternatively be randomly generated from a collection of key story concepts and syntax rules for generating sentences, paragraphs, or stories. The key story concept 120 functions as an object or concept that the user will represent on the blank story scene 130 later in the game. The key story concept 120 is preferably not emphasized or stressed (i.e. italicized, underlined, and/or highlighted) in the contextual story 110, but the key story concept 120 may alternatively be italicized, underlined, highlighted, or have any suitable emphasis. Emphasis of the key story concept may, however, be preferred during the second and subsequent attempts if the user fails on their first attempt. The key story concept 120 is preferably a character, an object, an action of the character, an adjective for the scene or an object, an adverb, a metaphor/simile, a concept, an implied idea, and/or any suitable interpretation or idea stated or suggested in the contextual story. In one example, the contextual story may be: “Kaz is on the red tree. Brad is reading a book below her on the bench”, and the key story concepts may be: “Kaz”, “Brad”, and “a book”. The contextual story 110 is preferably displayed for as long as a user desires, but alternatively, the contextual story 110 may move off the screen after a program-determined amount of time.

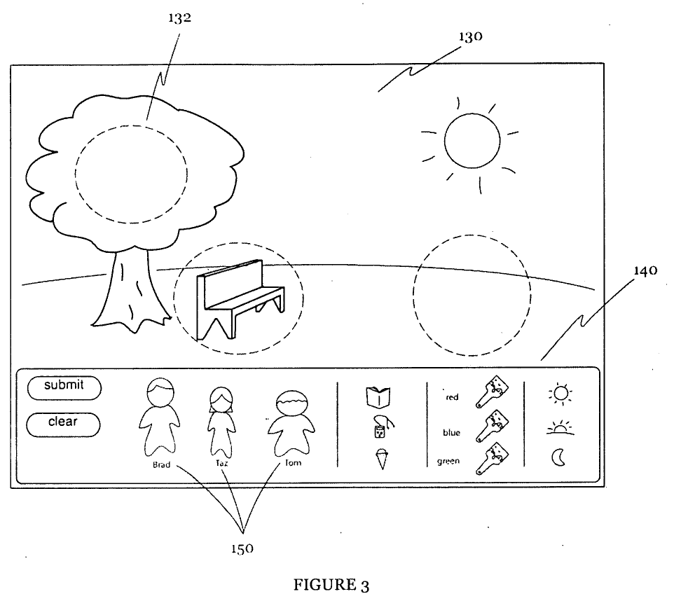

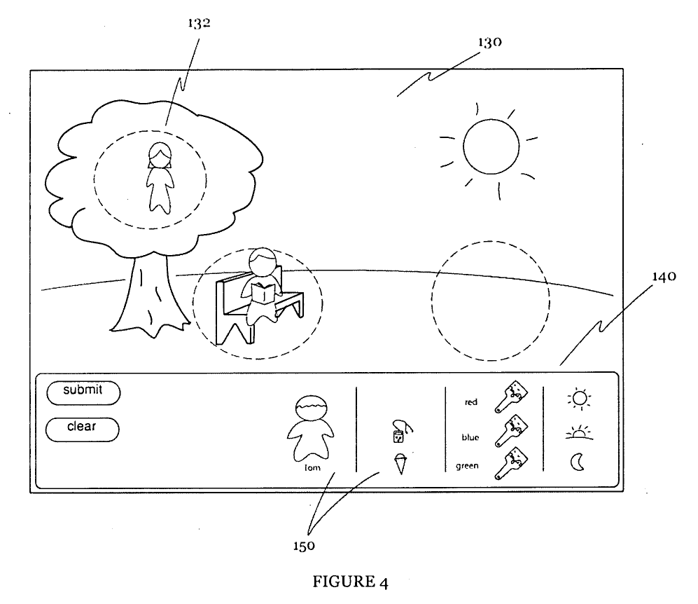

As shown in FIG. 3 and 4, the blank story scene 130 of the preferred embodiment functions to provide a setting for a user to create a user-generated scene based on the contextual story 110. The blank story scene 130 is preferably a graphical image on a computer screen, but may alternatively be an animation, a 3D graphical environment, virtual reality goggles, a video, a physical electronic device, or any suitable device facilitating the reproduction of the contextual story 110. The blank story scene 130 preferably detects a story object 150 when a story object 150 is within the bounds of the blank story scene 130. Preferably, the blank story scene 130 is the scene or environment where the contextual story 110 occurred. The blank story scene 130 preferably includes representations of items described in the contextual story 110 such as trees, fountains, benches, etc., but alternatively may include no items described in the blank story scene 130 or optionally, synonymous items (items that are from similar groups as in chairs and sofas) from the blank story scene 130. Alternatively, the blank story scene 130 may be an empty scene without any connections to the blank story scene 130 or may even include representations that did not actually occur in the contextual story 110 (an incorrect representation). Of course, the blank story scene may include any suitable scene depiction.

Additionally, the blank story scene 130 of the preferred embodiment has a plurality of hotspots 132 located on or near different items depicted in the blank story scene 130. The hotspots 132 are regions where story objects 150 can be detected. The story objects preferably cause the hotspots 132 to be highlighted, outlined, or emphasized in any suitable manner. The story objects 150 additionally snap or reposition to the hotspots 132 to facilitate positioning of story objects. In another embodiment, the hotspots 132 are locations on a physical playing surface with RFID tag sensors, optical sensors, or any suitable electrical identification device to detect RFID tagged or electrically tagged story objects 150.

The scene palette 140 of the preferred embodiment functions to provide an assortment of optional story objects 150 that a user can use to create a user-generated scene based on a contextual story 110. The scene palette 140 is preferably a collection of story objects 150, of which, at least one is associated with a key story concept 130. The scene palette 140 preferably has multiple story objects 150 related to a category that describes a key story concept 120, and preferably, each key story concept 120 has one associated story object 150 and one or more non-associated story object (an incorrect story object). The associated story object and non-associated story object are preferably from the same category such as “characters”, “colors”, “objects”, “actions” etc. Preferably, the scene palette 140 is located off to one side of the blank story scene, and story objects 150 of the scene palette 140 are preferably arranged by groups such as characters, colors, objects, etc., but any suitable arrangement or organization of the story objects 150 may be used. During the execution of the game, the user preferably drags a story object 150 from the scene palette 140 to the blank story scene 130 or more preferably to hotspots 132 of the blank story scene 130, but the story object 150 may be added to the blank story scene in any suitable manner. Alternatively, the scene palette 140 may be integrated with the blank story scene 130. In this alternative embodiment, the user must remove story objects 150 from the blank story scene 130, preferably by dragging the story objects 150 out of the blank story scene 130.

The story object 150 of the preferred embodiment functions to be an object a user can add to the blank story scene 130 to create a user-generated scene based on a contextual story 110. The story object 150 is preferably a graphical representation of a character, an object, an action of the character, adjective for the scene or an object, adverbs, metaphors, concepts, implied ideas, and/or any suitable interpretation or idea gathered from a story. The story object 150 is preferably applied to the blank story scene 130, but a story object 150 may alternatively or additionally be added, removed, rearranged, and/or modified. Additionally, a story object 150 may be applied to a second story object 150 or blank story scene 130. A story object 150 is preferably applied to a second story object 150 or blank story scene to modify, imply ownership, or achieve any suitable result of associating two story objects 150. As an example, a red paintbrush (representing the color red) may be dragged onto a blue ball to change the color of the blue ball to red. Additionally, adding a story object 150 may cause changes in the blank story scene 130. As an example, the story object 150 may become animated, audio may be played, or any suitable change to the blank story scene 130, the story object 150 or other story objects 150 may occur. The story object 150 is preferably added to the blank story scene 130 through a drag and drop interaction from the scene palette 140 to the blank story scene 130 or more preferably to a hotspot 132 of the blank story scene 130. The story object 150 may alternatively be added to the blank story scene 130 by clicking, selecting from a menu, or through any suitable interaction.

The validation software 160 of the preferred embodiment functions to compare the contextual story 110 with a user-generated scene composed of a blank story scene 130 and at least one story object 150. The validation software is preferably aware of the necessary story object or objects 150, the correct hotspot 132 for each story object 150, story objects 150 associated with other story objects 150, any alternatives to the user-generated scene, timing and ordering of objects, and/or any suitable characteristic of a user-generated scene. This awareness is preferably generated through the graphical user interface of the computer program, but may alternatively be generated through sensors or any other suitable method or device.

The game of the preferred embodiment may additionally include meta-cognitive hints 170 that function to improve performance of a user during a game. The meta-cognitive 170 hints are preferably audio instructions for various thinking strategies, such as a suggestion to visualize a story in their head, create mental associations of objects, to rephrase a story in a user's own words, to read the story out loud, or any suitable hint for user improvement in the game. The meta-cognitive hints 170 are preferably audio speech, but may alternatively be communicated using graphics, video, text, or any suitable medium. The meta-cognitive 170 hints are preferably provided after a user failed to give a correct user-generated scene, but alternatively, the hints may be supplied before each game, based on a timer, or at any suitable time during the game. Additionally, a meta-cognitive hint 170 may provide additional or increased guidance after each incorrect attempt at a game, after a previous meta-cognitive hint 170, and/or at any suitable time during the game.

### 2. The Method of an Interactive Storytelling Game

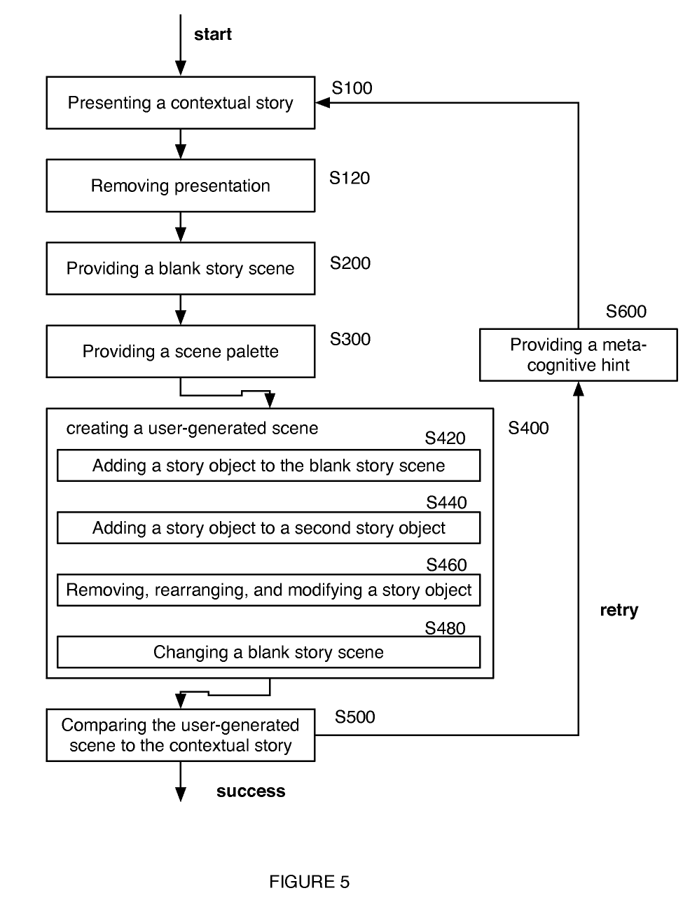

As shown in FIG. 5, the method of an interactive storytelling game of the preferred embodiment includes presenting a contextual story wherein the contextual story includes at least one key story concept S100, providing a blank story scene S200, providing a scene palette wherein the scene palette includes at least one story object associated with the at least one key story concept S300, facilitating the creation of a user-generated scene wherein the at least one story object may be applied to the blank story scene S400, and comparing the user-generated scene to the contextual story S500. The method of an interactive storytelling game functions to encourage a user (e.g. a child) to engage in an attention retaining game while developing thinking skills such as reading comprehension, retaining of information, visualizing information, and simultaneous processing of information. The method of an interactive storytelling game is preferably implemented in a computer software program or website application, and the method preferably allows a child to reproduce a short textual story by adding characters and items to a pre-designed scene. The method may alternatively be implemented in any suitable combination of media such as audio, video, animation, an electronic board game (using RFID tags and readers, optical sensors, or any suitable electrical identification system) and/or any suitable implementation of the method.

Step S100, which includes presenting a contextual story wherein the contextual story includes at least one key story concept, functions to provide a model story or scene that a user will attempt to reproduce later in the game. The contextual story is preferably presented in the form of a text, but alternatively, may be an audio reading of a story, a video, and/or any suitable depiction of a story. The contextual story is preferably selected based on a difficulty level, and the difficulty level is preferably altered based on user performance during previous games. The key story concept 120 is preferably a character, an object, an action of the character, an adjective for the scene or an object, an adverb, a metaphor/simile, a concept, an implied idea, and/or any suitable interpretation or idea stated or suggested in the contextual story. The contextual story preferably includes at least one key story concept, but may additionally include any number of key story concepts.

Step S200, which includes providing a blank story scene, functions to provide an empty scene for a user to add a story object or objects to create a user-generated scene based on the contextual story. The blank story scene preferably includes all elements of the contextual story but with the exception of a depiction of the key story concepts. The blank story may alternatively include a story objects to represent the key story concepts in the wrong position, mixed up order, incorrect objects, additional story objects, or any suitable arrangement of story objects. In a variation of the preferred embodiment, the step of providing a blank story scene is preferably a user-generated scene from a previous round. This variation functions to provide continuity to the contextual story, and the user preferably updates the user-generated scene to match a current contextual story. The blank story scene preferably includes hotspots that function to detect a story object. The hotspots preferably position any story object dragged and dropped within a defined radius of the hotspot. The hotspots may additionally be emphasized when an object can be dropped onto the hotspot. The blank story is preferably displayed as graphics.

Step S300, which includes providing a scene palette wherein the scene palette includes at least one story object associated with the at least one key story concept, functions to provide tools to create a user-generated scene on the blank story scene. The scene palette preferably includes a plurality of story objects with at least one story object associated with the at least one key story concept. The plurality of story objects is preferably arranged in groups such as “characters”, “objects”, “actions”, “colors”, and/or any suitable category. The story objects are preferably displayed as graphics but may alternatively be text, audio, a video, or any suitable multimedia content.

Step S400, which includes facilitating the creation of a user-generated scene wherein the at least one story object is applied to the blank story scene, functions to add, modify, or arrange objects to represent the contextual story. Ideally, the user applies a story object for every key story concept. The story objects are preferably added to a particular hotspot or a particular subset of hotspots based on location clues included in the contextual story, but alternatively location may not matter (as in the case where the difficulty is set for a very young age). The placement of a story object relative to a second story object may additionally be included in creating a user-generated scene, and may include duplicating directional relationships, ownership of items, or any suitable representation of the contextual story. The creating of a user-generated scene is preferably performed through computer interactions such as dragging and dropping actions, selecting from menus, clicking buttons, and/or through any suitable interaction. Creating a user-generated scene preferably includes the sub-steps of adding story objects to the blank story scene S420, adding story objects to a second story object S440, removing, rearranging, or modifying story objects S460 and/or changing a blank story scene S480.

Step S500, which includes comparing the user-generated scene to the contextual story, functions to verify if the user has provided a correct user-generated scene. A validation software program preferably performs the comparison. Each contextual story has at least one key story concept, each key story concept is preferably associated with one story object in the blank story scene, and the validation software preferably checks to make sure each story object associated with a key story concept is in the blank story scene. Additionally, each key story concept may have an absolute position or alternatively a relative position in the scene, and the validation software preferably verifies the positioning information. In another additional alternative, a key story concept may be an adjective, action, adverb, or any suitable descriptive characteristic of an object, and the validation software preferably verifies each object (either story object or an object depicted in the blank story scene) have the correct characteristics. In another additional alternative, two or more key story concepts may require two or more story objects to be paired, and the validation software preferably checks this associations. The validation software preferably outputs a program response indicating if a user-generated scene is correct or incorrect, and may additionally indicate where the error occurred, how many errors, or any suitable information regarding the user-generated scene. The game preferably allows a user to retry the contextual story if answered incorrectly or move to a new contextual story.

An additional step of providing meta-cognitive hints to the user S600 functions to provide guidance to a user regarding how to improve at the game. The meta-cognitive hints preferably suggest a user to visualize a story in their head, create mental associations of objects, to rephrase a story in a user's own words, to read the story out loud, or any suitable hint for user improvement in the game. The meta-cognitive hints are preferably provided via audio speech, but may alternatively be communicated using graphics, video, text, or any suitable medium. The meta-cognitive hints are preferably provided after a user supplies an incorrect user-generated scene, but alternatively, the hints may be supplied before each game, based on a timer, or at any suitable time during the game. Additionally, a meta-cognitive hint 170 may increase the amount of guidance after each incorrect attempt at a game, after a previous meta-cognitive hint 170, and/or at an suitable time during the game.

As a person skilled in the art will recognize from the previous detailed description and from the figures and claims, modifications and changes can be made to the preferred embodiments of the invention without departing from the scope of this invention defined in the following claims.

We claim:

1. An interactive storytelling game to facilitate children reading comprehension comprising:
a contextual story that includes at least one key story concept;
a blank story scene;
a scene palette that includes at least one story object that is associated with the at least one key story concept; and
a validation engine that compares a user-generated scene with the contextual description.

2. The game of claim 1 wherein the story object is adapted to be applied to the blank story scene to form a user-generated scene.

3. The game of claim 1 wherein the blank story scene includes a hotspot adapted to detect a story object.

4. The game of claim 1 wherein the contextual description is presented as a textual story.

5. The game of claim 1 further comprising a meta-cognitive hint adapted to aid a user.

6. The game of claim 1 wherein the game is presented graphically on a computer screen.

7. The game of claim 6 wherein the contextual description and the blank story scene are not displayed concurrently.

8. The game of claim 1 wherein the palette includes at least one story object not associated with a key story concept of the contextual description.

9. The game of claim 8 wherein the story objects of the scene palette relate to a category that describes a key story concept.

10. The game of claim 9 wherein the category of story objects is selected from the group consisting of characters, objects, and colors.

11. A method for facilitating children reading comprehension through an interactive storytelling game, comprising the steps:
presenting a contextual story that includes at least one key story concept;
providing a blank story scene;
providing a scene palette that includes at least one story object associated with the at least one key story concept;
facilitating the creation of a user-generated scene wherein the at least one story object can be applied to the blank story scene; and
comparing the user-generated scene to the contextual story.

12. The method of claim 11 wherein the step of providing a blank story scene includes providing a blank story scene with hotspots that detect a story object.

13. The method of claim 11 wherein the step of comparing the user generated scene to the contextual is implemented in a computer program.

14. The method of claim 11 further comprising the step removing the contextual story from view prior to providing a blank story scene.

15. The method of claim 11 further comprising the step providing a meta-cognitive hint for the user.

16. The method of claim 15 wherein the step of providing a meta-cognitive hint occurs before the step of providing a contextual story.

17. The method of claim 11 wherein the step of facilitating the creation of a user-generated scene further comprises facilitating the addition of a story object to the blank story scene to form the user-generated scene.

18. The method of claim 17 wherein the step of facilitating the creation of a user-generated scene further includes facilitating the addition of a story object to a second story object.

18. The method of claim 18 wherein the step of facilitating the creation of a user-generated scene further includes facilitating the removal, rearrangement, and modification of a story object.

19. The method of claim 11 wherein the step of facilitating the creation of a user-generated scene further includes facilitating the change of the blank story scene.

20. An interactive storytelling game to facilitate children reading comprehension comprising:
means for providing a contextual story that includes at least one key story concept;
means for providing a blank story scene and a scene palette that includes at least one story object that is associated with the at least one key story concept; and
means for comparing a user-generated scene with the contextual description.
